(19) United States
(12) Patent Application Publication
(10) Pub. No.: US 2026/0001744 A1
(43) Pub. Date: Jan. 1, 2026

(54) LIFTING TOOL

(71) Applicant: BAKER HUGHES ENERGY TECHNOLOGY UK LIMITED, Bristol (GB)

(72) Inventors: Duy Hoang Tuong LE, Ho Chi Minh City (VN); Vu Hoai LE, Ho Chi Minh City (VN); Tuan TRUONG QUANG, Ho Chi Minh City (VN); Khoa Minh TRAN, Ho Chi Minh City (VN); Minh Dinh Nhat TRAN, Ho Chi Minh City (VN)

(21) Appl. No.: 18/880,988

(22) PCT Filed: Jul. 7, 2023
(86) PCT No.: PCT/EP2023/025315

§ 371 Date: Jan. 3, 2025

(30) Foreign Application Priority Data
Jul. 8, 2022 (GB) 2210019.2

(51) Int. Cl. B66C 13/08; B66C 1/66; B66C 23/52; E21B 33/035

(52) U.S. Cl. CPC B66C 13/08; B66C 1/66; B66C 23/52; E21B 33/035

(57) ABSTRACT

A lifting tool for lifting, installing and/or retrieving oil and gas production equipment or carbon storage equipment. The lifting tool includes a base configured to be removably connected to the equipment, and a fixing device mounted to the base and configured to be connected to a lifting line extending to a lifting device, wherein the lifting tool is configured such that a position of the fixing device is continuously adjustable along a line extending across at least part of the base so as to adjust an offset between the fixing device and a centre of gravity of the lifting tool. A method of lifting, installing and/or retrieving oil and gas production equipment or carbon storage equipment using the lifting tool is also provided.

### TECHNICAL FIELD

The present disclosure relates to a lifting tool which may be used to lift, install and/or retrieve oil and gas production equipment or carbon storage equipment. The lifting tool has an adjustable attachment and can be used to compensate for asymmetric loads in the equipment.

### BACKGROUND

In the field of subsea oil and gas (hydrocarbon) production, well fluid is commonly produced and communicated from a well. Subsea wellhead assemblies are typically used in the production of hydrocarbons extracted from the subterranean formations below the seabed. Subsea wellhead assemblies generally include a wellhead housing attached at a wellbore opening, where the wellbore extends through one or more hydrocarbon producing formations. Wellhead assemblies also typically include christmas trees (XTs) connecting to an upper end of the wellhead housing. The XTs control and distribute the fluids produced from the wellbore.

The XTs are typically installed onto the wellhead housing by attaching wire or drill pipe to the XT via a lifting tool which is attached to the XT for lowering the XT subsea to the wellhead housing. Often the tree is asymmetric such that the tree's centre of gravity is not coincident with the axis of a main annulus of the tree. In other words, the tree's centre of gravity may be offset from the axis of the main annulus or offset from the central axis thereof. If no correction is made for this, the XT may tilt while being lowered to the seabed thus preventing the tree from landing properly onto the wellhead housing. The asymmetric tree can be balanced with added weights. However, this requires a stronger lowering wire or drill pipe to be provided and also results in significant additional materials being required (with a resulting additional cost in producing the XT).

In other applications in the oil and gas industry and in carbon storage applications, similar problems may be encountered where it is desirable to lift equipment having an offset centre of gravity.

The present disclosure provides a lifting tool and methods of using the lifting tool which seek to overcome these problems.

### SUMMARY

From a first aspect, the disclosure provides a lifting tool for lifting, installing and/or retrieving oil and gas production equipment or carbon storage equipment. The lifting tool comprises: a base configured to be removably connected to the equipment; a fixing device mounted to the base and configured to be connected to a lifting line extending to a lifting device, wherein the lifting tool is configured such that a position of the fixing device is continuously adjustable along a line extending across at least part of the base so as to adjust an offset between the fixing device and a centre of gravity of the lifting tool.

As the position of the fixing device is continuously adjustable, an offset between the fixing device and the centre of gravity of the lifting tool may be adjusted to any desired amount. Further, in any example of the disclosure, the position of the fixing device may be adjusted and then fixed or set at any desired offset.

At least in some examples, the position of the fixing device is continuously adjustable so as to adjust an offset between the lifting line and the centre of gravity of the lifting tool, or at least in some examples, between a lifting point on the fixing device and the centre of gravity of the lifting tool. The lifting point on the fixing device may be defined by a point of contact between the lifting line (or an extension thereof) and the fixing device. In any example, the lifting point may be located on an axis along which the lifting line extends.

At least in some examples, this will allow a standard lifting tool to be used with many different shapes and/or sizes and/or types and/or weights of equipment.

At least in some examples of the disclosure, the lifting tool may further comprise a mechanism for adjusting the position of the fixing device.

In some examples of the disclosure, the mechanism may be configured to be remotely actuated.

In these and other examples of the disclosure, the mechanism may be configured to be actuated by an ROV.

In any example of the disclosure, the mechanism may comprise a linear actuator.

In any example of the disclosure, the mechanism may comprise a threaded screw.

In some examples, the lifting tool may further comprise a drive component having an internal threaded surface for engaging with the threaded screw such that rotation of the threaded screw moves the drive component along the threaded screw. The fixing device may be configured to move with the drive component.

In some examples, the drive component may comprise a pin extending through the fixing device transverse to the threaded screw.

In some examples, the fixing device may comprise a body, the pin extending from a first side of the body through an aperture therein to a second, opposite side of the body.

In some examples, the lifting tool may further comprise a housing in which the threaded screw is mounted, the housing having planar side walls which extend parallel to the threaded screw. The body may be configured to fit over the housing and to engage with the planar side walls such that the housing acts to guide and or stabilise the movement of the fixing device.

From a further aspect of the disclosure, a method of lifting, installing and/or retrieving oil and gas production equipment or carbon storage equipment is provided. The method comprises: attaching a lifting tool according to any of the example of the disclosure to the equipment; and before or after attaching the lifting tool to the equipment, adjusting the position of the fixing device to adjust an offset between the fixing device and a centre of gravity of the lifting tool.

In any example, the method may further comprise connecting the fixing device to a lifting line, wherein when the lifting tool and the equipment are suspended by the lifting line, the lifting line is aligned with the centre of gravity of a combined weight being lifted via the lifting line.

From a further aspect of the disclosure, a method of installing oil and gas equipment or carbon storage equipment subsea is provided, the method comprising: attaching a lifting tool according to any example of the disclosure to the equipment; connecting the fixing device to a lifting line; lowering the equipment with the fixing device offset from the centre of the lifting tool so as to align the lifting line with the centre of gravity of a combined weight being lifted via the lifting line; adjusting the position of the fixing device to bring the lifting line into alignment with the centre of gravity of the lifting tool; before or after adjusting the position of the fixing device, disconnecting the lifting tool from the equipment; and retrieving the lifting tool.

From a further aspect of the disclosure, a method of retrieving subsea oil and gas equipment or carbon storage equipment is provided, the method comprising: connecting the fixing device of a lifting tool according to any example of the disclosure to a lifting line; lowering the lifting tool to the equipment with the fixing device positioned to align the lifting line with the centre of gravity of the lifting tool; connecting the lifting tool to the equipment; before or after connecting the lifting tool to the equipment, adjusting the position of the fixing device to be offset from the centre of gravity of the lifting tool so as to align the lifting line with the centre of gravity of a combined weight to be lifted via the lifting line; and raising the lifting tool and the equipment.

In any example of the disclosure, the adjusting the position of the fixing device may be affected by an ROV or a diver rotating a threaded screw which drives movement of the fixing device, or the adjusting the position of the fixing device may be affected by a linear actuator, wherein the linear actuator is remotely actuated by a hydraulic or electrical signal, or wherein the linear actuator is actuated by an ROV or diver.

Although certain advantages are discussed below in relation to the features detailed above, other advantages of these features may become apparent to the skilled person following the present disclosure.

### BRIEF DESCRIPTION OF THE DRAWINGS

One or more non-limiting examples will now be described, by way of example only, and with reference to the accompanying figures in which:

FIG. 1 is a schematic view showing different stages in the installation of a XT on the seabed using a lifting tool according to an example of the disclosure;

FIG. 2 is a schematic view showing different stages in the removal of a XT from the seabed using a lifting tool according to an example of the disclosure;

FIG. 3A is an isometric view of a lifting tool according to an example of the disclosure taken from a first side of the lifting tool;

FIG. 3B is a second isometric view of the lifting tool of FIG. 3A taken from a second, opposite side of the lifting tool;

FIG. 4 is a partial section through the isometric view of the lifting tool of FIG. 3A;

FIG. 5 is a section through the lifting tool of FIG. 4, taken along line L-L and showing the fixing device in a first position;

FIG. 6 is the section through the lifting tool of FIG. 5 but showing the fixing device in a second position;

FIG. 7A is an isometric view of a further lifting tool according to an example of the disclosure taken from a first side of the lifting tool; and

FIG. 7B is a partial section through the isometric view of the lifting tool of FIG. 7A.

### DETAILED DESCRIPTION

A lifting tool for lifting, installing and/or retrieving oil and gas production equipment or carbon storage equipment is provided. The lifting tool may be used in any example of the disclosure either onshore or inshore for a lifting operation in a workshop or at a site for testing or transport of equipment. The lifting tool may also be used offshore in any example of the disclosure for lifting equipment on board vessels or platforms or for lifting equipment between vessels and/or platforms offshore during transportation of the equipment.

The lifting tool may further be used in any example of the disclosure for deployment and/or retrieval of equipment for use subsea.

In any example of the disclosure, the lifting tool comprises: a base configured to be removably connected to the equipment; a fixing device mounted to the base and configured to be connected to a lifting line extending to a lifting device, wherein the lifting tool is configured such that a position of the fixing device is continuously adjustable along a line extending across at least part of the base so as to adjust an offset between the fixing device and a centre of gravity of the lifting tool.

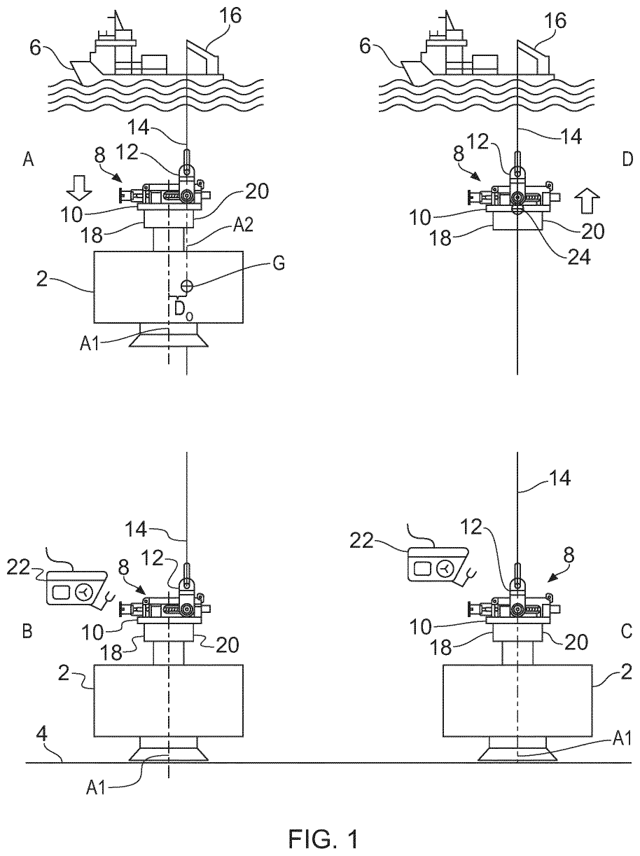

Referring to FIG. 1, a number of stages in an example method of installing subsea equipment, in the example shown, a subsea wellhead member 2 is shown. In some examples such as that shown, the subsea wellhead member 2 may be installed on the seabed 4. In other examples (not shown here) the subsea equipment could be installed onto an insitu structure rather than the seabed. It will be understood that the subsea wellhead member 2 could take many different forms.

At least in some examples of the disclosure however, the subsea wellhead member 2 may be a XT (christmas tree). A subsea wellhead member could be installed from any suitable location above the installation site. In some examples, the subsea wellhead member could be transported to an offshore platform and then installed from that platform. In the example shown in FIG. 1, the subsea wellhead member 2 may be transported to the installation site by and then installed from a floating vessel 6.

To install the subsea wellhead member 2, a lifting tool 8 is attached to the subsea wellhead member 2. The lifting tool 8 comprises a base 10 and a fixing device, for example a padeye 12 mounted to base 10. The fixing device or padeye 12 is connected to a lifting line 14 which is in turn connected to a lifting device 16. In the example shown, the lifting device 16 is located on the vessel 6 and may for example take the form of a crane or a lifting arm. In other examples, a winch or pulley system could also be used as the lifting device. The connecting steps described above may for example be carried out manually on the vessel before commencing to lower the subsea wellhead member 2.

In the first stage of the method of FIG. 1, as shown at A, the subsea wellhead member 2 is shown being lowered to the seabed. The centre of gravity of the subsea wellhead member 2 is offset from a central axis as described above. To stop or reduce tilting of the subsea wellhead member 2 while it is being lowered, the padeye (for example, the point at which the padeye 12 is connected to the lifting line) is therefore positioned to be offset by a distance Do from a first axis A1, here a vertical axis, extending through the centre of the lifting tool 8 so as to align the lifting line 14 with a second axis A2 extending through the centre of gravity G of the combined weight being lifted via the lifting line 14. In some examples, the combined weight may be made up by only the subsea wellhead member 2 and the base 10 and fixing device of the lifting tool 8. In other examples such as that shown in FIG. 1 however, the lifting tool 8 may include a further structure such as a cap 18 extending outwardly from the base 10 and away from the fixing device. In some examples, the base 10 of the lifting tool 8 may be connected to the cap 18, for example by a plurality of bolts or by a threaded connection. In other examples, the base 10 and the cap 18 may be formed as a single component, for example being forged as a single body.

Although it could take any suitable form, in any example including the example of FIG. 1, the cap 18 may be substantially cylindrical. The cap may be positioned such that a longitudinal axis of the cap 18 is aligned with or corresponds to the first axis A1.

The base 10 of the lifting tool 8 may also take any suitable form. In any example, the base 10 may be substantially cylindrical. At least in some examples, the base 10 may be wider than the cap 18 or (as in FIG. 1) may have a greater diameter than the diameter of the cap 18. The longitudinal, central axis of the base 10 may be aligned with or correspond to the longitudinal axis of the cap 18. In some examples, the base 10 may extend beyond one or more outer edges 20 of the cap 18.

As shown at B, the subsea wellhead member 2 is lowered to a subsea location, for example, the seabed 4, until it comes to rest. The subsea wellhead member 2 may then be secured in place as required. A ROV (remotely operated vehicle) 22 may then be used to adjust the position of the padeye 12 before retrieving the lifting tool 8 to the surface as will be described in further detail below. In other examples, the adjustment may be carried out by operating a linear actuator from a remote location as will be described in further detail below. In still further examples, the adjustment could be carried out manually by a diver.

As shown at C, the position of the padeye 12 may be adjusted until the lifting line 14 is brought into alignment with the first axis A1. In this position, it will be understood that the offset between the lifting line 14 or the second axis A2 and the first axis A1 is zero, or in some other examples, close to zero. The first axis A1 may be a vertical axis extending through the centre of gravity 24 of the lifting tool 8. In some examples, as in the example of FIG. 1 the first axis A1 may extend through the centre of the base 10. Once the lifting line 14 is in alignment with the first axis A1, the lifting tool 8 and the cap 18 (or, in some examples, just the lifting tool 8) may be disconnected from the subsea wellhead member 2. It will be understood that, at least in some examples, the lifting tool 8 is configured such that its centre of gravity is in line with the central axis of the base 10. Further, when the cap 18 may cylindrical in form and may be axially aligned with the central axis of the base 10 such that the lifting tool 8 is configured to be balanced along the central axis or with a zero offset from the first axis A1 when attached to any cylindrical and axially aligned cap.

As shown at D, the lifting tool 8 may then be retrieved from the seabed by lifting the lifting line 14 by the lifting device 16.

Although not shown in the drawings, it will be appreciated that once the lifting tool 8 has been retrieved (for example, when it is back on the vessel 6) the lifting line 14 may be detached from the padeye 12.

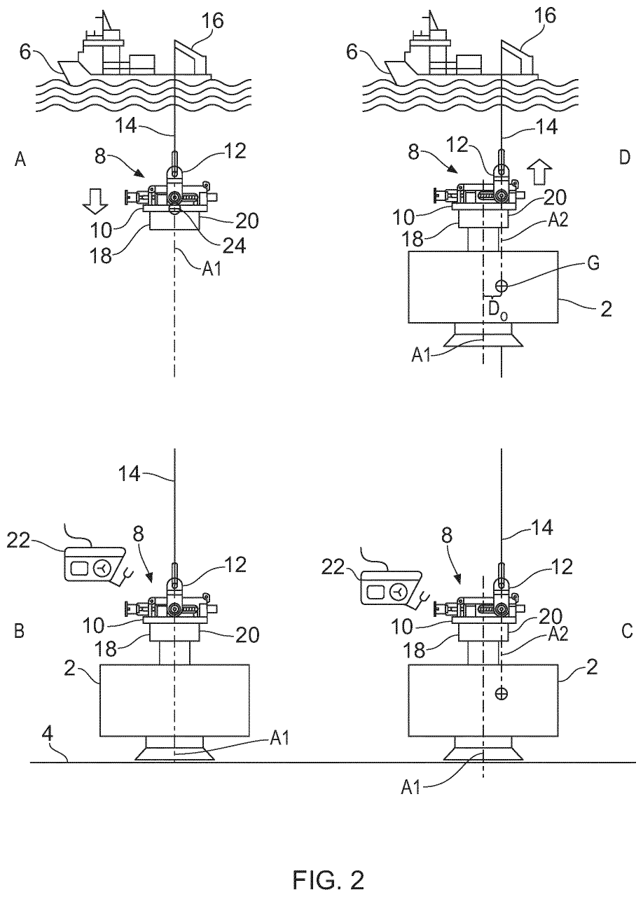

FIG. 2 shows a number of stages in an example method of removing the subsea wellhead member 2 of FIG. 1 from the seabed 4.

As shown at A in FIG. 2, the lifting tool 8 including the cap 18 may be lowered from the vessel 6 towards the seabed 4 via the lifting line 14 connected between the padeye 12 and the lifting device 16. To do this, the position of the padeye 12 may be adjusted such that the lifting line 14 is in alignment with the first axis A1.

As shown at B, the lifting tool 8 may be landed on the subsea wellhead member 2 and may then be guided into position and secured to the subsea wellhead member 2 by an ROV 22. The Lifting tool may be secured in place as required and an ROV may be used to operate a locking mechanism. When the tool is confirmed fully locked to the equipment, the ROV 22 may then be used to adjust the position of the padeye 12 to the position shown at C in which the axis A2 is offset by a distance Do from the first axis A1. In other examples, the adjustment may be carried out by operating a linear actuator from a remote location as will be described in further detail below.

The lifting device 16 can then raise the lifting tool 8 and the subsea wellhead member 2 via the lifting line 14 such that the subsea wellhead member 2 may be retrieved back into the vessel 6 and taken back ashore for maintenance or replaced as necessary.

It will be appreciated that the size, shape and mass of subsea wellhead members to be installed on the seabed may vary significantly depending on the project and or the configuration of the equipment for which they are to be used. As will be described in further detail below, the position of the padeye of the lifting tool 8 according to the disclosure is continuously adjustable so as to adjust an offset between the lifting line (which may extend along the second axis A2 described above) and the centre of gravity of the lifting tool (located on the first axis A1 described above). At least in some examples therefore, the padeye position on the lifting tool may be adjusted to be aligned with the centre of gravity at any point from for example the centre of the lifting tool 8 to a maximum possible offset of the centre of gravity from the central axis. At least in some examples, this will allow a standard lifting tool 8 to be used with many different shapes and/or sizes and/or types and/or weights of subsea wellhead members. This is in contrast to known arrangements in which a bespoke lifting tool may be designed and made for the installation or removal of one particular subsea wellhead member.

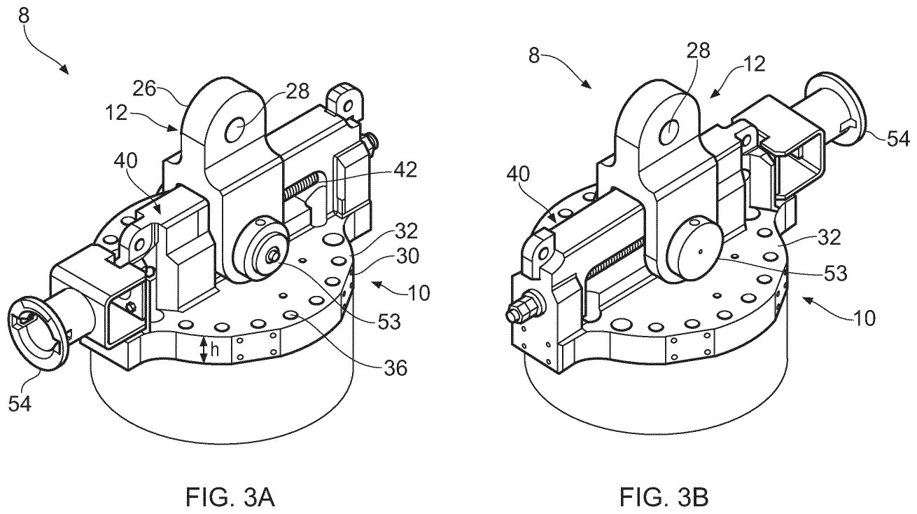

FIGS. 3A, 3B and 4 to 6 show an example lifting tool 8 according to the disclosure in further detail. As described above, the lifting tool 8 includes a base 10 and a padeye 12 movably mounted to the base 10. The padeye 12 is an example of a fixing device to which a lifting line (for example a wire or piping) may be attached. In some examples at least, the padeye 12 comprises a flange 26 and an aperture 28 extending through the flange 26. A lifting line may therefore be attached to the padeye 12 by a variety of methods, for example by passing the pin of a shackle (not shown) through the aperture 28 and securing the shackle.

The base 10 could take any desired form and could for example be cuboid. The base of this example is substantially cylindrical in shape, having an outer edge 30 which may be curved over at least circumferential portions thereof. The base 10 has a first surface 32 and a second, opposite surface 34 spaced from the first surface 32. A depth of the base 10 is defined by the height h of the outer edge 30, extending between the first and second surfaces 32, 34. A number of holes 36 extend through the base 10 from the first surface 32 to the second surface 34. In the example shown, the holes are provided close to the outer edge 30 and are distributed around at least part of the circumference of the base 10. The base 10 may be fixed to a cap 18 of the lifting tool 8 which is in turn fixed to a subsea wellhead member or may be fixed directly to a subsea wellhead member by fixing means (not shown). In any example, the fixing means could be any suitable fixing such as nuts and bolts.

In any example of the disclosure, the lifting tool 8 may be provided with a mechanism 40 for continuously adjusting a position of the padeye 12, specifically in at least some examples adjusting the position of the aperture 28 in the padeye 12, relative to the central axis A1 of the lifting tool 8. The mechanism 40 may take many different forms and some alternative examples are shown and described below. As the position of the padeye is continuously adjustable, the position thereof may be set (and fixed when needed) at any desired point along a line extending across at least part of the base.

At least in some examples of the disclosure, the mechanism 40 is configured such that the position of the padeye 12 is continuously adjustable along a straight line (the line L-L in the example shown), where the straight line extends across at least a part of the first surface 32. In some examples of the disclosure, the mechanism 40 may include a threaded screw 42 and the padeye 12 may be adapted to be moved linearly along the threaded screw 42 when the screw is rotated.

In other examples of the disclosure (not shown) the padeye 12 could be adapted to move with a moveable part of a linear actuator such that the position of the padeye 12 is continuously adjustable along a straight line corresponding to the direction of movement of the moveable part. It will be understood that any suitable type of linear actuator including a hydraulic actuator or an electromechanical actuator could be used.

In the example shown in FIGS. 3A to 6, the mechanism 40 for continuously adjusting the position of the padeye 12 includes a housing 44 for mounting the threaded screw 42. The housing 44 extends outwardly from and/or perpendicular to the first surface 32. In the example shown, the housing 44 extends diametrically across the first surface 32 through the centre thereof.

A pin 46 is also movably mounted in the housing 44. The pin is provided with a hole 48 extending therethrough. Threads (not shown) are formed on the inner surface of the hole 48. The threaded screw 42 passes through the hole 48 and is configured such that the threads on the threaded screw 42 engage with the threads on the inner surface of the hole 48 such that the pin is moved along the threaded screw 42 as the threaded screw is rotated. It will be understood therefore that the pin 46 forms a drive component to be driven along the screw thread. The hole 48 is configured such that the pin 46 extends transverse to the threaded screw 42.

The housing 44 may have planar side walls 50, not shown which extend perpendicular to the first surface and parallel to the direction of travel of the padeye 12. The padeye 12 comprises a body 52 from which the flange 26 extends. The body 52 may be hollow and may be configured to fit over the housing 44 and to engage with the planar side walls 50 such that the housing 44 acts to guide and or stabilise the movement of the padeye 12. The pin 46 may comprise a trunnion. In other words, the pin 46 may extend from a first side of the body 52 of the padeye 12, through an aperture in the padeye and a corresponding aperture in the housing to a second, opposite side of the body 52. The pin 46 may be held in place in the body 52 by a respective stop member 53 provided at either end thereof and configured to abut against the respective sides of the body 52.

It will be understood that the pin 46 could be attached or fixed to the body 52 in a number of other ways. In any example however, the body 52 is configured to move with the pin 46 so that the movement of the pin 46 along the threaded screw 42 causes the position of the padeye 12 to be adjusted.

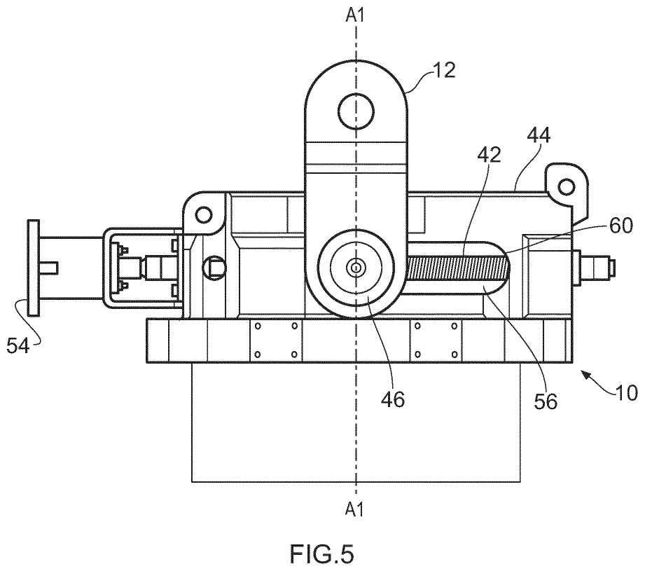

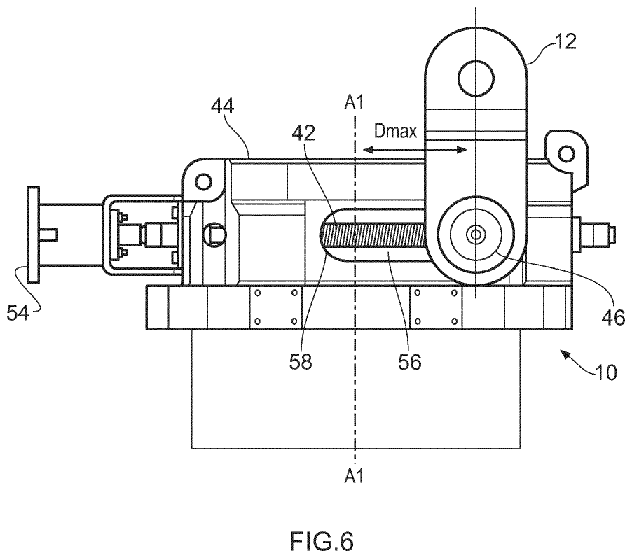

In the example shown, the mechanism 40 is configured to allow the position of the padeye 12 to be continuously adjusted or to be adjusted to any desired linear location between a position in which a lifting line attached to the padeye 12 is aligned with the central axis of the lifting tool 8 (this position is shown in FIG. 5 for example) and a maximum desired offset Dmax of the padeye 12 (or a lifting line attached thereto) from the central axis as shown in FIG. 6.

As described above, it is desirable to be able to adjust the position of the padeye 12 on the lifting tool 8 in any environment, including a subsea environment. In any example of the disclosure, the subsea adjustment may be carried out by an ROV. In some examples, such as the example of FIGS. 3A and 3B, an ROV may be used to turn the threaded screw 42. This may be achieved in various ways. At least in some examples and as shown in FIG. 3A, an ROV bucket 54 may be connected to a first end of the threaded screw 42 and may extend beyond the outer edge 30 of the base 10 such that and ROV can engage with the ROV bucket 54 to adjust the position of the padeye 12. In alternative examples, any suitable handle (including an ROV D-handle or T-handle) could be provided to allow an ROV or a diver to turn the threaded screw 42 as required.

In other examples, which are not shown, a hydraulic connection (for example, a handle or a hot stab connection) could be used to actuate a hydraulic actuator or an electrical signal could be provided to drive an electromechanical actuator so as to adjust the position of the padeye.

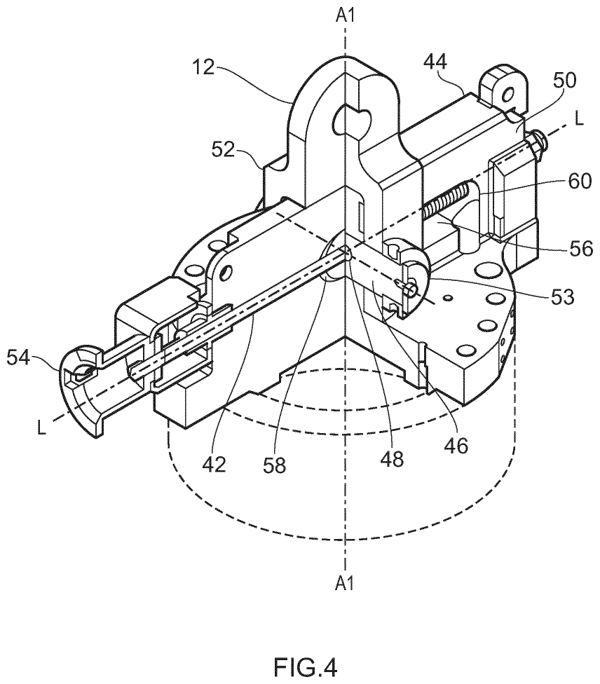

In the example shown in FIGS. 3A to FIG. 6, the housing 44 is configured such that the pin 46 can only move beyond the centre of the lifting tool 8 in a first direction, such that it can only move across one half of the diameter of the base 10. As seen in FIG. 4, this may be achieved by a passageway 56 extending through the housing and along which the pin 46 can travel. The passageway 56 has first and second ends 58, 60 (see FIGS. 5 and 6) which form stops for limiting the movement of the pin 46 (and hence the padeye 12) between the desired locations.

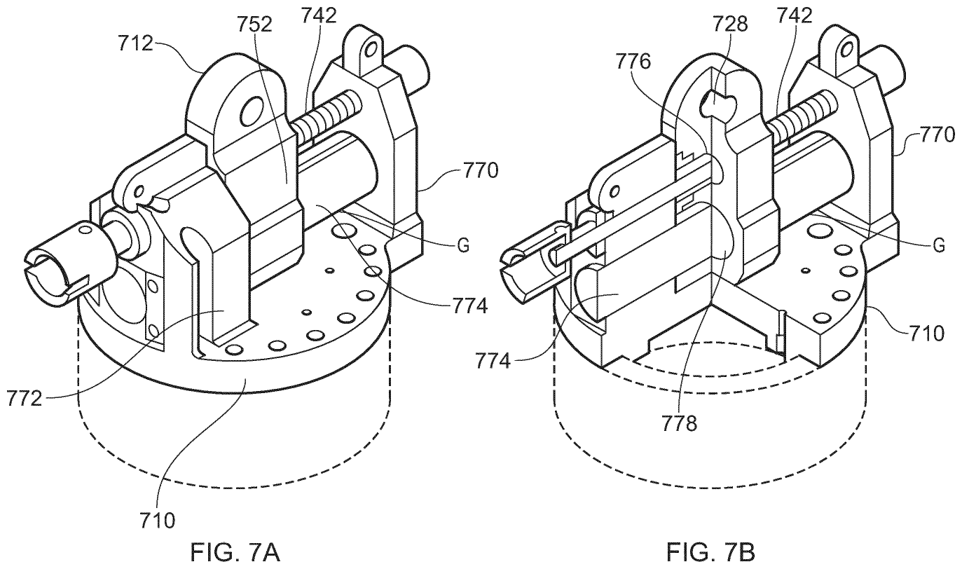

In other examples of the disclosure, such as the example of FIGS. 7A and 7B, the housing may for example comprise only spaced apart end walls 770, 772 for mounting the threaded screw 742 such that the threaded screw extends across a gap G formed between the end walls. To provide adequate support for the padeye 712 (which is adapted to carry significant loads as required), a shaft 774 may be mounted to extend between the end walls 770, 772 between the threaded screw 742 and the base 710. The padeye body 752 may be provided with a first threaded through aperture 776 which engages with the threaded screw 742 to move the padeye 712 as the threaded screw is rotated. The padeye body 752 also includes a second through aperture 778 which need not be threaded and within which the shaft 774 may slide as the padeye 712 moves along the threaded screw 742.

In this example, the movement of the padeye 12 may be limited only by the end walls 770, 772 of the housing. Thus, in the example shown, the end wall 770 is positioned such that, at one extremity of its motion, the padeye body 752 is in abutment with the end wall 770 and the centre of the aperture 728 in the padeye 712 to which a lifting line may be attached is aligned with the central axis (not shown in FIGS. 7A and 7B) of the lifting tool.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. A lifting tool for lifting, installing and/or retrieving oil and gas production equipment or carbon storage equipment, the lifting tool comprising:
a base configured to be removably connected to the equipment; and
a fixing device mounted to the base and configured to be connected to a lifting line extending to a lifting device,
wherein the lifting tool is configured such that a position of the fixing device is continuously adjustable along a line extending across at least part of the base so as to adjust an offset between the fixing device and a centre of gravity of the lifting tool.

2. The lifting tool as claimed in claim 1, further comprising a mechanism for adjusting the position of the fixing device.

3. The lifting tool as claimed in claim 2, wherein the mechanism is configured to be remotely actuated.

4. The lifting tool as claimed in claim 2, wherein the mechanism is configured to be actuated by an ROV.

5. The lifting tool as claimed in claim 2, wherein the mechanism comprises a linear actuator.

6. The lifting tool as claimed in claim 2, wherein the mechanism comprises a threaded screw.

7. The lifting tool as claimed in claim 6, further comprising a drive component having an internal threaded surface for engaging with the threaded screw such that rotation of the threaded screw moves the drive component along the threaded screw,
wherein the fixing device is configured to move with the drive component.

8. The lifting tool as claimed in claim 7, wherein the drive component comprises a pin extending through the fixing device transverse to the threaded screw.

9. The lifting tool as claimed in claim 8, wherein the fixing device comprises a body, the pin extending from a first side of the body through an aperture therein to a second, opposite side of the body.

10. The lifting tool as claimed in claim 9, further comprising a housing in which the threaded screw is mounted, the housing having planar side walls which extend parallel to the threaded screw,
wherein the body is configured to fit over the housing and to engage with the planar side walls such that the housing acts to guide and or stabilise the movement of the fixing device.

11. A method of lifting, installing and/or retrieving oil and gas production equipment or carbon storage equipment, the method comprising:
attaching the lifting tool as claimed in claim 1 to the equipment; and
before or after attaching the lifting tool to the equipment, adjusting the position of the fixing device to adjust an offset between the fixing device and a centre of gravity of the lifting tool.

12. The method as claimed in claim 11, further comprising connecting the fixing device to a lifting line,
wherein when the lifting tool and the equipment are suspended by the lifting line, the lifting line is aligned with the centre of gravity of a combined weight being lifted via the lifting line.

13. A method of installing oil and gas equipment or carbon storage equipment subsea, the method comprising:
attaching the lifting tool as claimed in claim 1 to the equipment;
connecting the fixing device to a lifting line;
lowering the equipment with the fixing device offset from the centre of the lifting tool so as to align the lifting line with the centre of gravity of a combined weight being lifted via the lifting line;
adjusting the position of the fixing device to bring the lifting line into alignment with the centre of gravity of the lifting tool;
before or after adjusting the position of the fixing device, disconnecting the lifting tool from the equipment; and
retrieving the lifting tool.

14. A method of retrieving subsea oil and gas equipment or carbon storage equipment, the method comprising:
connecting the fixing device of the lifting tool as claimed in claim 1 to a lifting line;
lowering the lifting tool to the equipment with the fixing device positioned to align the lifting line with the centre of gravity of the lifting tool;
connecting the lifting tool to the equipment;
before or after connecting the lifting tool to the equipment, adjusting the position of the fixing device to be offset from the centre of gravity of the lifting tool so as to align the lifting line with the centre of gravity of a combined weight to be lifted via the lifting line; and
raising the lifting tool and the equipment.

15. The method as claimed in claim 13, wherein the adjusting the position of the fixing device is affected by an ROV or a diver rotating a threaded screw which drives movement of the fixing device, or
wherein the adjusting the position of the fixing device is affected by a linear actuator, wherein the linear actuator is remotely actuated by a hydraulic or electrical signal, or wherein the linear actuator is actuated by an ROV or a diver.
